(19) United States
(12) Patent Application Publication
(10) Pub. No.: US 2010/0017566 A1
(43) Pub. Date: Jan. 21, 2010

(54) SYSTEM, METHOD, AND COMPUTER PROGRAM PRODUCT FOR INTERFACING COMPUTING DEVICE HARDWARE OF A COMPUTING DEVICE AND AN OPERATING SYSTEM UTILIZING A VIRTUALIZATION LAYER

(76) Inventor: Radoslav Danilak, Cupertino, CA (US)

Correspondence Address: Zilka-Kotab, PC, P.O. BOX 721120, SAN JOSE, CA, 95172-1120, US

(21) Appl. No.: 12/173,654

(22) Filed: Jul. 15, 2008

(51) Int. Cl. G06F 12/00

(52) U.S. Cl. 711/115; 711/E12.001

(57) ABSTRACT

A system, method, and computer program product are provided for interfacing computing device hardware of a computing device and an operating system. A portable memory device adapted for removable communication with a computing device including computing device hardware is provided. The portable memory device includes an operating system, and a virtualization layer for interfacing the computing device hardware of the computing device and the operating system.

### FIELD OF THE INVENTION

The present invention relates to computer devices and more particularly to interfacing hardware of such devices to operating systems.

### BACKGROUND

In general, there is no portability of operating system, applications, and some files between computers. Therefore, it is generally not possible to carry content for a computer on a removable storage device, such as a USB stick, to use on various computers. Operating systems such as Microsoft Vista and Windows XP are typically tied to computer hardware. Thus, storing these operating systems on an external serial advanced technology attachment (eSATA) key would not allow computer system environments to be portable, since the operating system would be tied to hardware.

There is thus a need for addressing these and/or other issues associated with the prior art.

### SUMMARY

A system, method, and computer program product are provided for interfacing computing device hardware of a computing device and an operating system. A portable memory device adapted for removable communication with a computing device including computing device hardware is provided. The portable memory device includes an operating system, and a virtualization layer for interfacing the computing device hardware of the computing device and the operating system.

### BRIEF DESCRIPTION OF THE DRAWINGS

FIG. 1 shows a method for interfacing computing device hardware of a computing device and an operating system utilizing a virtualization layer, in accordance with one embodiment.

FIG. 2 shows an apparatus for interfacing computing device hardware of a computing device and an operating system utilizing a virtualization layer, in accordance with one embodiment.

FIG. 3 shows an apparatus for interfacing computing device hardware of a computing device and an operating system utilizing a virtualization layer, in accordance with another embodiment.

FIG. 4 shows a method for interfacing computing device hardware of a computing device and an operating system utilizing a virtualization layer, in accordance with another embodiment.

FIG. 5 shows a method for interfacing computing device hardware of a computing device and an operating system utilizing a virtualization layer, in accordance with another embodiment.

FIG. 6 illustrates a system for delaying operations that reduce a lifetime of memory, if a desired lifetime duration exceeds an estimated lifetime duration, in accordance with another embodiment.

FIG. 7 illustrates a system for reducing write operations in memory, in accordance with one embodiment.

FIG. 8 illustrates an exemplary system in which the various architecture and/or functionality of the various previous embodiments may be implemented.

### DETAILED DESCRIPTION

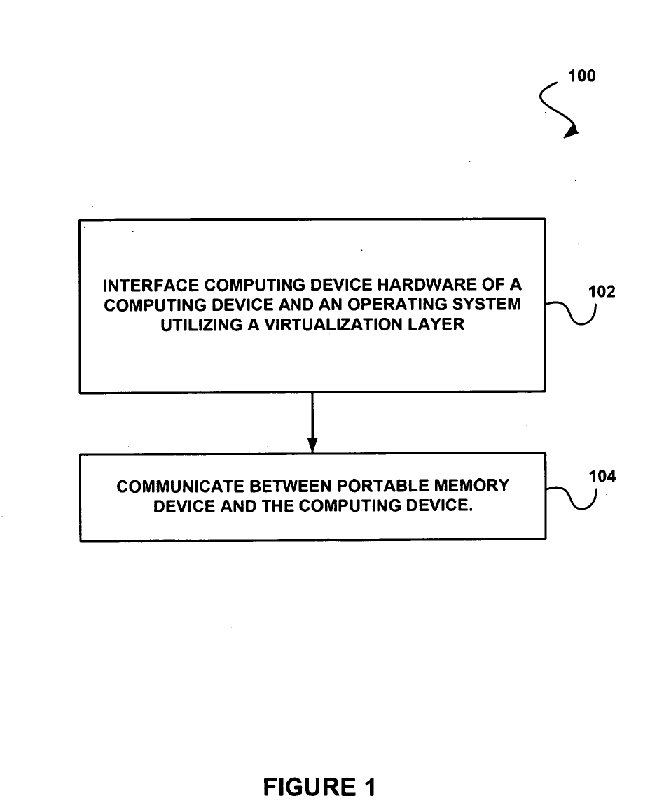

FIG. 1 shows a method 100 for interfacing computing device hardware of a computing device and an operating system utilizing a virtualization layer, in accordance with one embodiment. As shown, computing device hardware of a computing device and an operating system are interfaced utilizing a virtualization layer. See operation 102. In this case, a portable memory device adapted for removable communication with the computing device includes the operating system and the virtualization layer. As shown further, there is communication between the portable memory device and the computing device. See operation 104.

In the context of the present description, a portable memory device refers to any portable device capable of storing data. For example, in various embodiments, the portable memory device may include, but is not limited to, a removable hard disk drive, flash memory (e.g. a USB stick, etc.), removable storage disks (e.g. CDs, DVDs, etc.), eSATA disks, eSATA keys, and/or any other type of memory device.

Furthermore, in the context of the present description, a computing device refers to any device which may be used for computing. For example, in various embodiments, the computing device may include, but is not limited to, a desktop computer, a laptop computer, a handheld computer, a personal digital assistant (PDA) device, a mobile phone, and/or any other computing device that meets the above definition. Additionally, computing device hardware refers to any hardware associated with a computing device.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

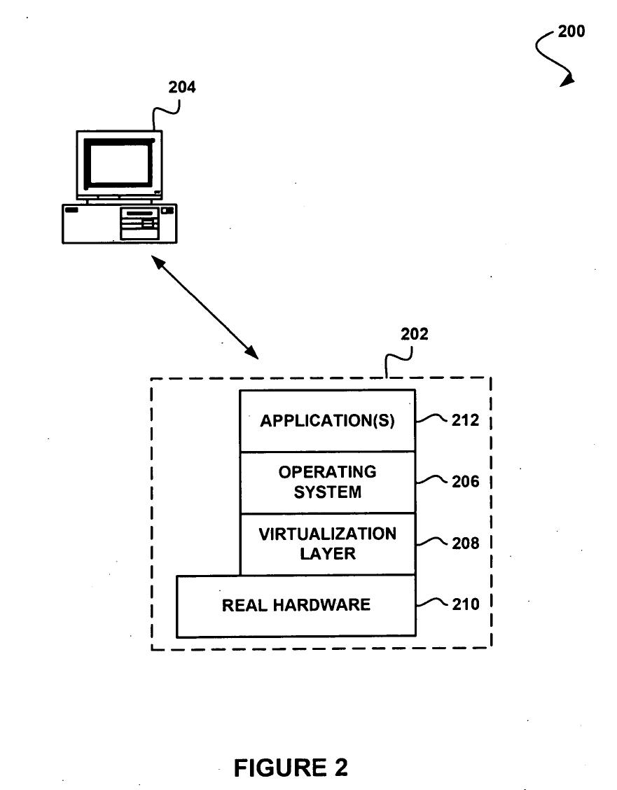

FIG. 2 shows an apparatus 200 for interfacing computing device hardware of a computing device and an operating system utilizing a virtualization layer, in accordance with one embodiment. As an option, the apparatus 200 may be implemented to carry out the method 100 of FIG. 1. Of course, however, the apparatus 200 may be implemented in any desired environment. It should also be noted that the aforementioned definitions may apply during the present description.

As shown, the apparatus 200 includes a portable memory device 202 adapted for removable communication with a computing device 204 including computing device hardware. As shown further, the portable memory device 202 includes an operating system 206 and a virtualization layer 208 for interfacing the computing device hardware of the computing device 204 and the operating system 206.

In this way, the operating system 206 may be run within a virtualization environment utilizing the virtualization layer 208. In the context of the present description, a virtualization layer refers to any layer that may be utilized to simulate or emulate at least one characteristic of a computing resource. In various embodiments, the virtualization layer 208 may include VMWare, Xen, and/or any other virtualization software.

Furthermore, the virtualization layer 208 may be employed under emulation, in either hardware or software. In these cases, a hypervisor or emulation may emulate hardware to which the operating system 206 is locked. In the context of the present description, a hypervisor refers to any virtualization platform that allows one or multiple operating systems to run on a computing device at the same time.

In one embodiment, the virtualization layer 208 may directly interface the computing device hardware of the computing device 204 with the operating system 206. In another embodiment, the virtualization layer 208 may indirectly interface the computing device hardware of the computing device 204 with the operating system 206. In still another embodiment, the virtualization layer 208 may interface another operating system running on the computing device hardware of the computing device 204.

As an option, the portable memory device 202 may further include portable memory device hardware 210. In this case, the portable memory device hardware 210 may be capable of performing security services. For example, in some cases, anti-piracy protection may be employed by the memory device hardware 210 by locking the operating system 206. In this case, the portable memory device 202 may provide any suitable mechanism for locking the operating system 206.

In another embodiment, an eSATA key may be utilized. In this case, SATA commands may be used to provide unique memory device identification to which the locking of operating system 206 or other software is provided. In the case that the portable memory device 202 is connected to the computing device 204 over PCI-Express, the memory device 202 may provide a network interface card (NIC) with a unique Ethernet MAC number needed by the operating system 206.

Furthermore, the portable memory device 202 may include one or more software applications 212. In various embodiments, the applications 212 may include applications associated with the operating system 206 and/or applications separate from operating system applications. For example, the applications 212 may include word processing applications, spreadsheet applications, e-mail applications, and/or any other type of software application.

As an option, the portable memory device 202 may include logic for delaying at least one operation that reduces the lifetime of the portable memory device 202. In the context of the present description, such operations may refer to a write operation, an erase operation, a program operation, and/or any other operation that is capable of reducing the aforementioned lifetime. Additionally, the lifetime may include at least one of a desired lifetime, an actual lifetime, and an estimated lifetime.

Furthermore, the operation may be delayed by delaying a command that initiates the operation. As another option, the delaying may further be based on the application that initiates the operation. In another embodiment, the delaying may be independent of the application that initiates the operation. In still another embodiment, the operation may be delayed if a desired lifetime duration exceeds an estimated lifetime duration. As another option, the portable memory device 202 may include logic for reducing write operations.

It should be noted that, in various embodiments, the memory mentioned may include a mechanical storage device (e.g. a disk drive including a SATA disk drive, a SAS disk drive, a fiber channel disk drive, IDE disk drive, ATA disk drive, eSATA disk, eSATA key, CE disk drive, USB disk drive, smart card disk drive, MMC disk drive, etc.) and/or a non-mechanical storage device (e.g. semiconductor-based, etc.). Such non-mechanical memory may, for example, include volatile or non-volatile memory. In various embodiments, the nonvolatile memory device may include flash memory (e.g. single-bit per cell NOR flash memory, multi-bit per cell NOR flash memory, single-bit per cell NAND flash memory, multi-bit per cell NAND flash memory, multi-level-multi-bit per cell NAND flash, large block flash memory, etc.). While various examples of memory are set forth herein, it should be noted that the various principles may be applied to any type of memory a lifetime for which may be reduced due to various operations being performed thereon.

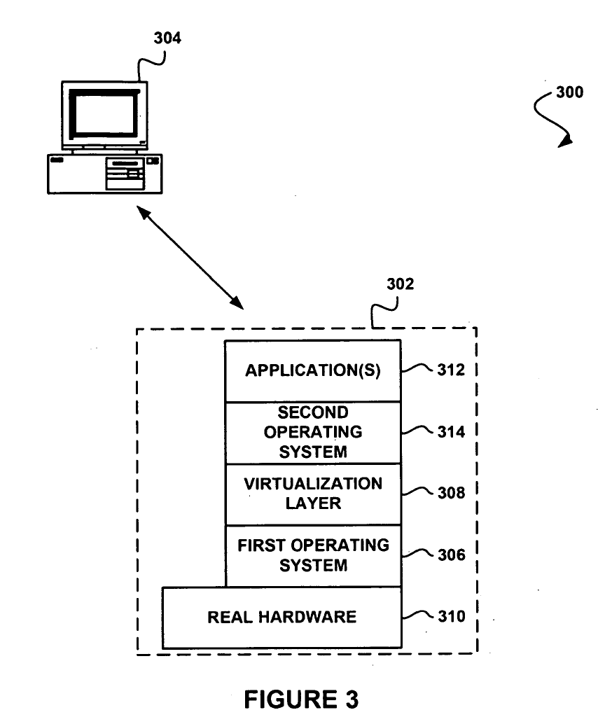

FIG. 3 shows an apparatus 300 for interfacing computing device hardware of a computing device and an operating system utilizing a virtualization layer, in accordance with another embodiment. As an option, the apparatus 300 may be implemented in the context of the architecture and/or functionality of FIGS. 1-2. Of course, however, the apparatus 300 may be implemented in any desired environment. Again, the aforementioned definitions may apply during the present description.

As shown, the apparatus 300 includes a portable memory device 302 adapted for removable communication with a computing device 304 including computing device hardware. As shown further, the portable memory device 302 includes a first operating system 306 and a virtualization layer 308 for interfacing the computing device hardware of the computing device 304 and the first operating system 306. As an option, the portable memory device 302 may further include portable memory device hardware 310. Furthermore, the portable memory device 302 may include one or more software applications 312.

In some cases, hardware may be significantly different between various computer devices to which the portable memory device 302 is attached. As an option, a hypervisor may run directly on hardware or under a second operating system 314, such as Linux, for example. By running under the second operating system 314, which includes hardware drivers for variety of hardware, it may be easier to create an emulation of standardized hardware for operating systems such as Windows XP or Vista, such that the operating system 306 may run under any hardware scenario.

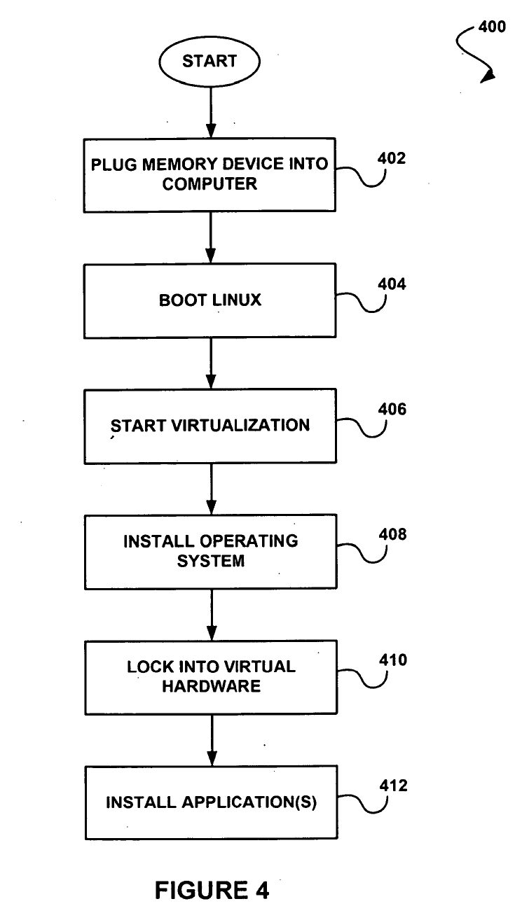

FIG. 4 shows a method 400 for interfacing computing device hardware of a computing device and an operating system utilizing a virtualization layer, in accordance with another embodiment. As an option, the present method 400 may be implemented in the context of the functionality and architecture of FIGS. 1-3. Of course, however, the method 400 may be carried out in any desired environment. Further, the aforementioned definitions may apply during the present description.

As shown, a portable memory device, such as a USB memory stick, eSATA disk, or eSATA key is plugged into a computer. See operation 402. A first operating system is then booted. See operation 404. In this case, the first operating system may include a Linux operating system. It should be noted that, in other embodiments, the first operating system may not be included. In this case, operation 404 may be omitted.

Once the first operating system is booted, virtualization begins. See operation 406. In this case, the virtualization may be initiated as part of a virtualization layer. In this case, virtualization refers to any technique utilized to simulate or emulate at least one characteristic of a computing resource. For example, the virtualization may include simulating or emulating characteristics corresponding to memory, a disk, a processor, a motherboard, a graphics card, a network card, and/or characteristics of any other computing resource.

Once the virtualization has been initiated, a second operating system is installed. See operation 408. In this case, the second operating system may be installed on a computing device hosting the portable memory device.

Once the second operating system is installed, the virtual hardware is locked. See operation 410. In this case, the computing device may lock into the virtual hardware.

Once the virtual hardware has been locked in, applications may be installed. See operation 412. In this case, the applications may be any applications stored on the portable memory device and may be installed on the computing device for use.

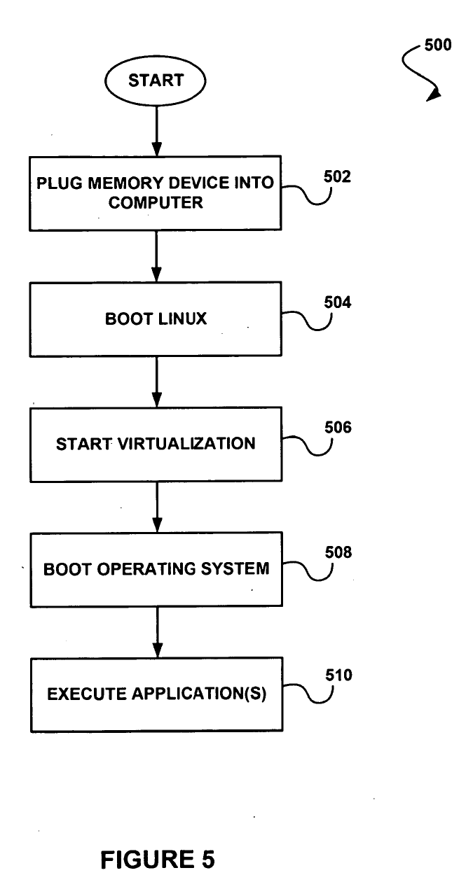

FIG. 5 shows a method 500 for interfacing computing device hardware of a computing device and an operating system utilizing a virtualization layer, in accordance with another embodiment. As an option, the present method 500 may be implemented in the context of the functionality and architecture of FIGS. 1-4. Of course, however, the method 500 may be carried out in any desired environment. Again, the aforementioned definitions may apply during the present description.

As shown, a portable memory device, such as a USB memory stick, eSATA disk, or eSATA key is plugged into a computer. See operation 502. A first operating system is then booted. See operation 504. Once again, the first operating system may include a Linux operating system or any other operating system that includes hardware drivers for variety of hardware. It should be noted that, in other embodiments, the first operating system may not be included. In this case, operation 504 may be omitted.

Once the first operating system is booted, virtualization begins. See operation 506. Once the virtualization has been initiated, a second operating system is booted. See operation 508. In this case, the second operating system may be booted by a computing device hosting the portable memory device.

Once the second operating system is booted, applications may be executed. See operation 510. In this case, the applications may be any applications stored on the portable memory device and may be executed by the computing device.

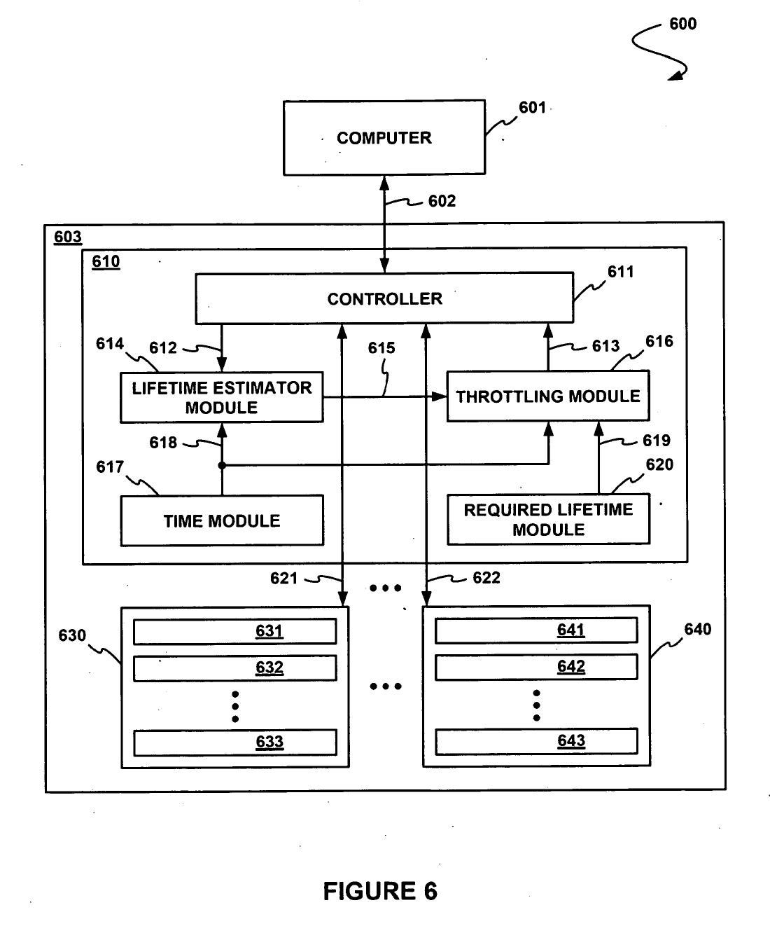

As noted above, in one embodiment, the portable memory device may include logic for delaying at least one operation that reduces the lifetime of the portable memory device. FIG. 6 illustrates a system 600 for delaying operations that reduce a lifetime of memory, if a desired lifetime duration exceeds an estimated lifetime duration, in accordance with another embodiment. As an option, the present system 600 may be implemented in the context of the details of FIGS. 1-5. Of course, however, the system 600 may be used in any desired manner.

As shown, included is a storage system 603 that comprises a plurality of storage mechanisms 630, 640. In one embodiment, the storage system 603 may represent one or more removable storage devices described in the context of FIGS. 1-5. At least one storage bus 602 couples at least one controller 611 with at least one computer 601. In various embodiments, the storage bus 602 may include, but is not limited to a serial advanced technology attachment (SATA) bus, serial attached SCSI (SAS) bus, fiber channel bus, memory bus interface, flash memory bus, NAND flash bus, integrated drive electronics (IDE) bus, advanced technology attachment (ATA) bus, consumer electronics (CE) bus, universal serial bus (USB) bus, smart card bus, multimedia card (MMC) bus, etc. Thus, the controller 611 is capable of being coupled between a system (e.g. computer 601) and secondary storage (such as at least one of the storage mechanisms 630, 640). Further included is at least one apparatus 610 for prolonging a lifetime of memory associated with the storage mechanisms 630, 640.

As shown, the apparatus 610 includes a controller 611coupled to the storage mechanisms 630, 640 via a plurality of corresponding buses 621, 622, respectively. The controller 611 uses a plurality of buses 621, 622 to control and exchange data with a plurality of storage mechanisms 630, 640 in order to execute commands received from the computer 601 via the storage bus 602. The storage mechanisms 630, 640 each include at least one module or block 631, 632, 633, 641, 642, and 643 for storing data. Further, at least a portion of the aforementioned commands are lifetime-reducing commands that have a negative impact on at least one module or block 631, 632, 633, 641, 642, 643. In use, the apparatus 610 serves for prolonging the lifetime of the storage mechanisms 630, 640, despite such lifetime-reducing commands.

To accomplish this, the controller 611 is coupled to a lifetime estimator module 614 via a corresponding bus 612. The apparatus 610 further includes a time module 617 coupled to the lifetime estimator module 614 via a bus 618, for providing a current time. In use, the lifetime estimator module 614 serves to receive commands communicated to the controller 611from the computer 601 via the storage bus 602. Further, the lifetime estimator module 614 computes an estimated lifetime assuming that the command(s) received through the bus 612 was executed.

With continuing reference to FIG. 6, the lifetime estimation module 614 is coupled to a throttling module 616 via a bus 615. The lifetime estimation module 614 uses the bus 615 to pass to the throttling module 616 the estimated lifetime for a command currently executed by the controller 611. The currently executed command may, in one embodiment, be the same as that received by the lifetime estimator module 614 via the bus 612 and may further be the same as that received by the controller 611 from the computer 601 via the storage bus 602.

The current time module 617 is also coupled to the throttling module 616 via the bus 618. Thus, the current time from the current time module 617 may be passed to the throttling module 616 as well. In one embodiment, the current time module 617 may be implemented, for example, as a simple counter incrementing at a constant time interval, etc.

The throttling module 616 is further coupled with a required lifetime module 620 via a bus 619, as well as to the controller 611 via a bus 613. In use, the required lifetime module 620 is adapted for storing a desired lifetime. By this design, the throttling module 616 may be configured to pass information to the controller 611 via the bus 613 to instruct the controller 611 to delay the execution of the current command.

In one embodiment, the throttling module 616 of the apparatus 610 may operate such that the execution of the current command is delayed until the effects of the execution on the lifetime is such that the estimated lifetime is longer or the same as the required lifetime stored in the required lifetime module 620. The functionality of the throttling module 616 may, in one embodiment, be as simple as providing a delay signal to the controller 611, if the estimated lifetime received via the bus 615 is shorter than the required lifetime received via the bus 619.

In another embodiment, the above-described functions of the controller 611, the lifetime estimator module 614, and the throttling module 616 may be applied to a group of commands received in predefined time intervals. Such arrangement may allow the system 600 to meet the required lifetime without unnecessarily throttling short bursts of commands that would otherwise reduce lifetime. By choosing the time interval, for example, as being one day, such a technique allows the system 600 to provide higher instantaneous performance for lifetime-reducing commands because, during some period of the day (e.g. nighttime, etc.), there may be intervals of time where there is a reduced frequency of lifetime-reducing commands compared to an average frequency of lifetime-reducing commands.

In one optional embodiment, coherency may be maintained over time. As an example of a coherency method, if lifetime-reducing command A is delayed, then all commands (lifetime-reducing or not) that depend on the data of A or the values resulting from the execution of the command A are also delayed.

In another embodiment, time may be replaced with various approximations of time, such as time that a disk is being powered up. In another embodiment, the computer 601, a RAID controller, and/or other device may provide additional information to increase precision of time tracked. Thus, when one or more of the storage mechanisms 630, 640 is turned off, the time counter is not counting. Since real time is advancing, this may unnecessarily reduce performance. In such scenario, the computer 601, software, and/or a controller may provide information about the time when the system 600 is turned off, for addressing such issue.

In another embodiment, the system 600 may be equipped with an intra-storage device redundancy capability for reducing cost and improving performance. In such embodiment, data may be moved between the individual storage mechanisms 630, 640, based on any aspect associated with a lifetime thereof. For instance, a situation may involve a first one of the storage mechanisms 630 including a set of data that is more frequently overwritten with respect to the data of a second one of the storage mechanisms 640. In such case, after a predetermined amount of time, such data may be moved from the first storage mechanism 630 to the second storage mechanism 640, and henceforth the first storage mechanism 630 or one or more blocks/modules 631, 632, 633 thereof may be used to store less-frequently written data or retired from further use.

To this end, storage device wear may be distributed appropriately to avoid one storage device from failing at a point in time that is vastly premature with respect to other storage devices of the group. Of course, the present technique may be applied not only among different storage devices, but also portions thereof. To this end, the lifetime of any memory components may be managed in such a manner.

In any case, the controller 611 may thus be equipped for reducing and/or distributing writes. By this feature, a lifetime of storage devices may be prolonged.

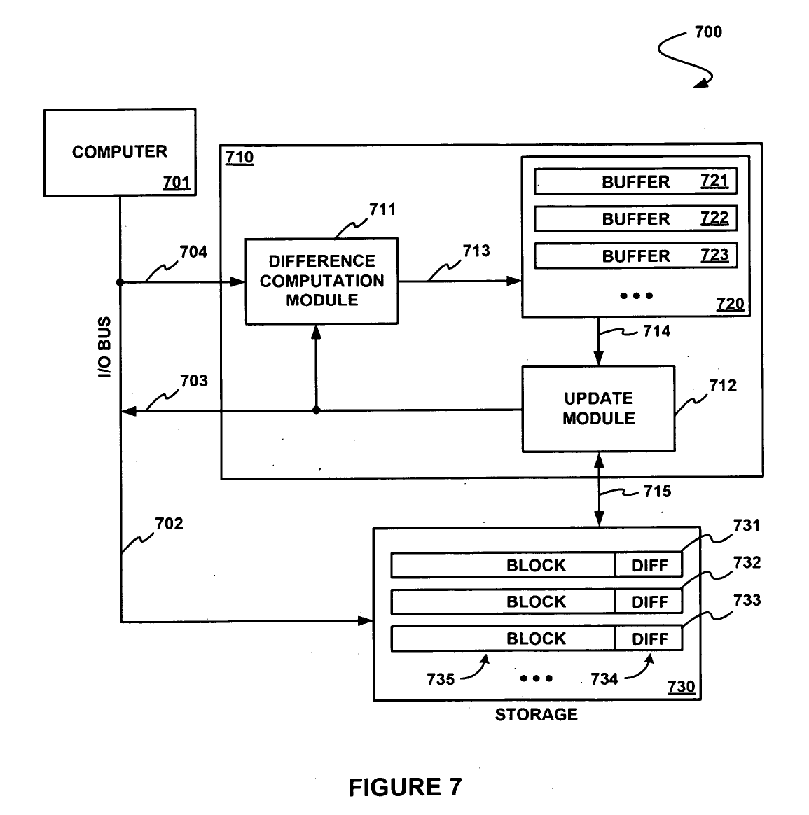

FIG. 7 illustrates a system 700 for reducing write operations in memory, in accordance with one embodiment. As an option, the present system 700 may be implemented in the context of the details of FIGS. 1-6. Of course, however, the system 700 may be used in any desired manner. Yet again, the aforementioned definitions may apply during the present description.

As shown, the system 700 includes a computer 701 coupled to a storage device 730 via an input/output (UO) bus 702, in a manner that will soon be set forth. The I/O bus 702 includes a read path 703 and a write path 704. The storage device 730 includes a plurality of storage blocks 731, 732, 733. The storage blocks 731, 732, 733 are written and read by the computer 701.

For reasons that will soon become apparent, a predetermined portion 734 of each of the storage blocks 731, 732, 733 may be allocated to store difference information that reflects any changes made to data stored in the remaining portion 735 of the corresponding storage block 731, 732, 733 by the computer 701. In various embodiments, a size of the predetermined portion 734 may be user configured. Further, the difference information stored therein may take any form.

Table 1 illustrates one possible format for representing an instance of difference information (a plurality of which may be stored in each predetermined portion 734 of the storage blocks 731, 732, 733).

TABLE 1

| Operation | Source Starting | | |
|---|---|---|---|
| Code | Address | Size | Data |
| END | N/A | N/A | N/A |
| Replace | <address> | <byte length> | <replacement data> |
| Move Up | <address> | <byte length> | <address from where data |
| | | | is to be moved> |
| Move | <address> | <byte length> | <address from where |
| Down | | | data is to be moved> |
| Insert | <address> | <byte length> | <data to be inserted> |
| Delete | <address> | <byte length> | N/A |

In the present embodiment, the operation code may represent an operation to be performed on the data stored in the remaining portion 735 of the corresponding storage block 731, 732, 733. Examples of such operations may include, but are not limited to end, replace, move up, move down, delete, insert, and/or any other operation, for that matter. As an option, such operations may each have an associated code for compact representation, (e.g. replace=‘001’, move up=‘010’, etc. ).

Further, the source starting address and size may point to and indicate the size (respectively) of the data stored in the remaining portion 735 of the corresponding storage block 731, 732, 733 which is to be the subject of the operation. Even still, in a situation where the operation mandates a replacement/modification of data, etc. , data itself may be stored as a component of the difference information. As yet another option, a compression algorithm may be applied to the difference information for more efficient storage. As another option, in a situation where the operation mandates a move of the data, a source location of the data may be designated, and not necessarily the data itself, since such data is contained in an original storage block.

In another embodiment, new operations may be adaptively created. For example, repeating sequences of a first operation may be replaced by a new second operation. Such new second operation may optionally describe a sequence of the first operation. In this way, new operations may be adaptively created such that the system 700 may optimally adapt itself to new applications.

Of course, the data structure of Table 1 is set forth for illustrative purposes only and should not be construed as limiting in any manner whatsoever. For example, an instance of difference information may simply include the data to be replaced (without any complex commands, etc. ).

Further provided is an apparatus 710 for reducing write operations in memory. Such apparatus 710 includes a coalescing memory 720 including a plurality of coalescing buffers 721, 722, 723. In one embodiment, a size of each of the coalescing buffers 721, 722, 723 may be of a predetermined size (e.g. 4 Kb, etc. ) that may correlate with a minimum block portion that may be written to each of the storage blocks 731, 732, 733 in a single operation. Further, in various embodiments, the coalescing buffers 721 may include on-chip storage, external memory, DRAM, SRAM, etc.

The coalescing memory buffers 721, 722, 723 each hold an instance of difference information (e.g. see Table 1, for example) for the corresponding storage blocks 731, 732, and 733. In other words, a first one of the coalescing memory buffers 721 holds an instance of difference information for a first one of the storage blocks 731, a second one of the coalescing memory buffers 722 holds an instance of difference information for a second one of the storage blocks 732, a third one of the coalescing memory buffers 723 holds an instance of difference information for a third one of the storage blocks 733, and so on.

The apparatus 710 further includes an update module 712 coupled to the coalescing memory 720 via a bus 714 for writing the difference information stored in the coalescing memory buffers 721, 722, 723 to the corresponding storage blocks 731, 732, and 733. In one embodiment, such write may be initiated upon one of the coalescing memory buffers 721, 722, 723 being filled with at least one instance of difference information (and thus constituting a minimum write size to the appropriate one of the storage blocks 731, 732, and 733). To accomplish this write, the update module 712 is coupled to the storage device 730 via a bus 715. As further shown, an output of the update module 712 is coupled to the i/O bus 702 via the read path 703.

Even still, a difference computation module 711 is coupled to the update module 712 via the read path bus 703, coupled to the I/O bus 702 via the write path bus 704, and further coupled to the coalescing memory 720 via a bus 713. In use, the difference computation module 711 is capable of reading data from the storage device 730 and further reconstructing a current state of such data using the difference information from the associated storage block 731, 732, and 733, and/or coalescing memory buffers 721, 722, 723.

The difference computation module 711 is further capable of writing data to the storage device 730 by first reconstructing a current state of such data (similar to the read operation above), identifying a difference between such current state and a state that would result after a write operation (initiated by the computer 701), and populating the coalescing memory buffers 721, 722, 723 with one or more instances of difference information to be used to update the associated storage block 731, 732, and 733, as appropriate.

In various embodiments, the difference computation module 711 may employ any desired technique for identifying the aforementioned difference(s). For example, various string matching algorithms, data motion estimation techniques, etc. may be utilized, for example. In still additional embodiments, the differences may be determined on a byte-by-byte basis.

Further, computation of the difference may involve any one or more of the following: finding what byte strings are inserted, finding what byte strings are deleted, finding what byte strings are replaced, finding what byte strings are copied, determining if byte strings are updated by adding values, finding copies of storage blocks and creating references to them, finding block splits, finding block merges, etc.

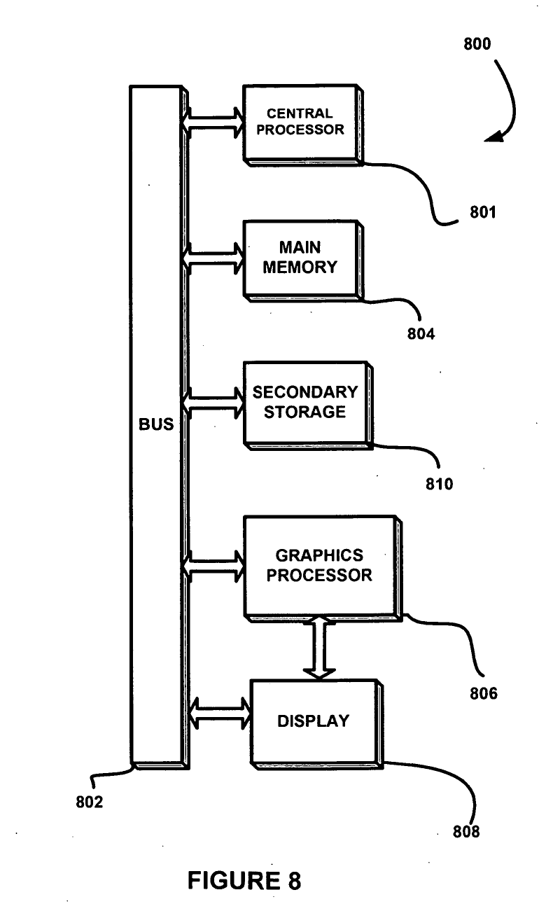

FIG. 8 illustrates an exemplary system 800 in which the various architecture and/or functionality of the various previous embodiments may be implemented. As shown, a system 800 is provided including at least one host processor 801 which is connected to a communication bus 802. The system 800 also includes a main memory 804. Control logic (software) and data are stored in the main memory 804 which may take the form of random access memory (RAM).

The system 800 also includes a graphics processor 806 and a display 808, i.e. a computer monitor. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 804 and/or the secondary storage 810. Such computer programs, when executed, enable the system 800 to perform various functions. Memory 804, storage 810 and/or any other storage are possible examples of computer-readable media.

In one embodiment, the architecture and/or functionality of the various previous figures may be implemented in the context of the host processor 801, graphics processor 806, an integrated circuit (not shown) that is capable of at least a portion of the capabilities of both the host processor 801 and the graphics processor 806, a chipset (i.e. a group of integrated circuits designed to work and sold as a unit for performing related functions, etc. ), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, lap-top computer, and/or any other type of logic. Still yet, the system 800 may take the form of various other devices including, but not limited to, a PDA, a mobile phone device, a television, etc.

Further, while not shown, the system 800 may be coupled to a network [e.g. a telecommunications network, local area network (LAN), wireless network, wide area network (WAN) such as the Internet, peer-to-peer network, cable network, etc. ) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus, comprising:
a portable memory device adapted for removable communication with a computing device including computing device hardware, the portable memory device including:
an operating system, and
a virtualization layer for interfacing the computing device hardware of the computing device and the operating system.

2. The apparatus as set forth in claim 1, wherein the virtualization layer directly interfaces the computing device hardware of the computing device.

3. The apparatus as set forth in claim 1, wherein the virtualization layer indirectly interfaces the computing device hardware of the computing device.

4. The apparatus as set forth in claim 3, wherein the virtualization layer interfaces another operating system running on the computing device hardware of the computing device.

5. The apparatus as set forth in claim 1, wherein the portable memory device further includes portable memory device hardware.

6. The apparatus as set forth in claim 5, wherein the portable memory device hardware is capable of performing security services.

7. The apparatus as set forth in claim 1, and further comprising logic for delaying at least one operation that reduces a lifetime of the portable memory device.

8. The apparatus as set forth in claim 7, wherein the lifetime includes at least one of a desired lifetime, an actual lifetime, and an estimated lifetime.

9. The apparatus as set forth in claim 8, wherein the operation is delayed by delaying a command that initiates the operation.

10. The apparatus as set forth in claim 8, wherein the delaying is further based on an application that initiates the operation.

11. The apparatus as set forth in claim 8, wherein the delaying is independent of an application that initiates the operation.

12. The apparatus as set forth in claim 8, wherein the operation includes an erase operation.

13. The apparatus as set forth in claim 8, wherein the operation includes a program operation.

14. The apparatus as set forth in claim 8, wherein the operation is delayed if a desired lifetime duration exceeds an estimated lifetime duration.

15. The apparatus as set forth in claim 1, and further comprising logic for reducing the write operations.

16. The apparatus as set forth in claim 1, wherein the portable memory device includes a volatile memory device.

17. The apparatus as set forth in claim 1, wherein the portable memory device includes a nonvolatile memory device.

18. An method, comprising:
interfacing computing device hardware of a computing device and an operating system utilizing a virtualization layer, wherein a portable memory device adapted for removable communication with the computing device includes the operating system and the virtualization layer; and
communicating between the portable memory device and the computing device.

19. The method as set forth in claim 18, wherein the virtualization layer directly interfaces the computing device hardware of the computing device.

20. A computer program product embodied on a computer readable medium, comprising:
computer code for interfacing computing device hardware of a computing device and an operating system utilizing a virtualization layer, wherein a portable memory device adapted for removable communication with the computing device includes the operating system and the virtualization layer.
